(19) United States
(12) Patent Application Publication
(10) Pub. No.: US 2004/0009386 A1
(43) Pub. Date: Jan. 15, 2004

(54) Gas distributor for fuel cells

(76) Inventors: Bertil Nygren, Skogsvagen (SE); Markku Rissanen, Nordanbygatan (SE); Stefan Backa, Vasagatan 7 (SE); Jari Ihohen, Kungshamra (SE); Frederick Jaouen, Kungshamra (SE)

Correspondence Address: YOUNG & THOMPSON, 745 SOUTH 23RD STREET 2ND FLOOR, ARLINGTON, VA, 22202

(21) Appl. No.: 10/332,265

(22) PCT Filed: Jul. 4, 2001
(86) PCT No.: PCT/SE01/01533

(30) Foreign Application Priority Data
Jul. 7, 2000 (SE) 0002588-2

(51) Int. Cl. H01M 8/02; C22C 28/00

(52) U.S. Cl. 429/38; 428/546

(57) ABSTRACT

A gas distribution member (3; 20) for a polymer membrane fuel cell comprising a highly porous, sintered material. The sintered material comprises fibers of an inorganic material. The fibers have a diameter in the range 0.5-50 μ, preferably 2-25, most preferred 8-22 μ, and a length in the range up to 3 mm, and the porosity is in the range of more than 50% by volume, preferably more than 90 percent by volume. Disclosed is also a fuel cell comprising said gas distribution member, and a method of making the same.

The present invention relates to polymer fuel cells and in particular to a gas distribution member for such fuel cells, a method of making such a member, and to a fuel cell comprising such a member.

### BACKGROUND OF THE INVENTION

The distribution of gas, e.g. hydrogen and oxygen as well as water management respectively, in a fuel cell, is of great importance for the function and efficiency of the fuel cell. A low pressure drop must be maintained in the cell, and the distribution of fuel gases and water vapor over the active surfaces must be reasonably uniform. If these requirements are not met the efficiency will inevitably be reduced, and as a consequence, the economic feasibility of the entire plant will be negatively affected.

Thus, there are certain technical requirements that are put on a device for the distribution of said gases. In addition, the material that the distribution device is made of must be electrically conductive.

The gas distribution members that are in current use are most often made of graphite. There is provided a plate of graphite in which channels have been made, commonly by milling, which is an expensive manufacturing method. The graphite plate is assembled with a “paper”, or sheet material, made of carbon fiber and carbon black, to form an aggregate. The sheet material (paper) ascertains the gas distribution, and the graphite plate with gas channels ascertains the pressure level, i.e. the pressure drop is kept at a reasonable level.

One example of a gas distribution graphite plate is disclosed in U.S. Pat. No. 4,175,165. However, in this patent it is the bipolar plates of the fuel cell assembly that constitute the gas distribution member.

A problem with these known gas distribution members is that in practical use, often times high contact resistances occur between the different components on the member.

### SUMMARY OF THE INVENTION

Thus, the object of the present invention is to make available gas distribution means for fuel cells where the drawbacks of the prior art devices have been remedied. This is achieved with the gas distribution member as claimed in claim 1.

By providing a gas distributor according to the invention, fuel cells can be given a more compact design, there will be a better electrical contact between different components, catalyst and electrical connections, and the gas distribution will be more efficient.

In a further aspect of the invention there is provided a fuel cell comprising the inventive distribution member. The fuel cell according to the invention is defined in claim 11.

In still another aspect there is provided a method of making a gas distribution member, which is defined in claim 13.

### BRIEF DESCRIPTION OF THE DRAWINGS

The invention will now be described in closer detail with reference to the drawings, in which

FIG. 1a shows schematically the structure of a polymer membrane fuel cell;

FIG. 1b shows the individual components of the cell in FIG. 1a in more detail;

FIG. 2 is a schematic view in cross section of a gas distribution member according to the present invention;

FIG. 3 is a schematic view in cross section of another embodiment of a gas distribution member according to the present invention;

FIG. 4 is a schematic view in cross section of a further embodiment of a gas distribution member according to the present invention;

FIG. 5 shows one possible channel structure for a gas distribution member according to the invention; and

FIG. 6 is a cross-section through an embodiment of a the gas distribution member according to the invention.

### DETAILED DESCRIPTION OF PREFERRED EMBODIMENTS

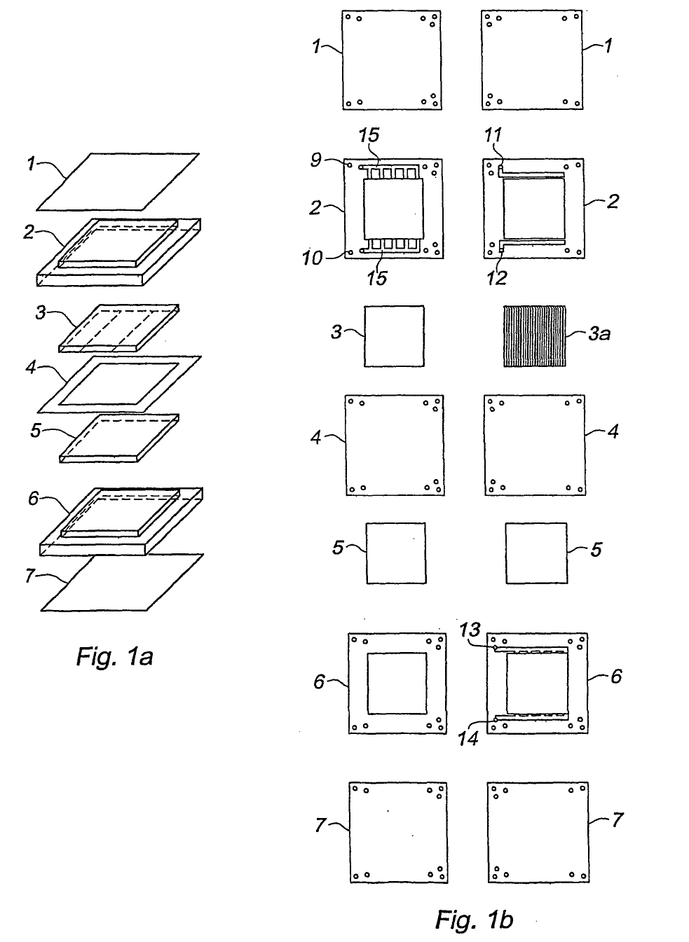

First the general design of a polymer fuel cell will be described with reference to FIGS. 1a-b

Thus, as shown in FIGS. 1a and 1b a fuel cell structure comprises a conductive anode (bipolar) plate 1. An anode sealing frame 2 is provided adjacent the bipolar plate 1. This frame is provided with a central, rectangular opening for an anode gas distribution member 3. The frame 2 is also provided with an anode gas inlet 9 and an outlet 10, and distribution channels are formed as well as a water inlet and a water outlet 11, 12, respectively. The anode gas distribution member 3 is provided with a plurality of narrow water channels 3a on the opposite side of the member 3, with reference to the anode plate 1. A proton exchange membrane 4 is arranged for co-operation with the plate 1 for sandwiching the frame 2 and the distribution member 3 between the membrane 4 and the plate 1.

The cathode side of the fuel cell is structured in a similar manner as the anode side. Thus, the opposite side of the membrane 4 is arranged for co-operation with a conductive cathode plate 7 for sandwiching a cathode sealing frame 6 and a cathode gas distribution member 5 between the membrane 4 and the plate 7. The cathode distribution member 5 may not be provided with water channels as the anode distribution member 3, but it is preferably not provided with any such channels. The cathode sealing frame 6 is provided with a cathode gas inlet 13 and an outlet 14.

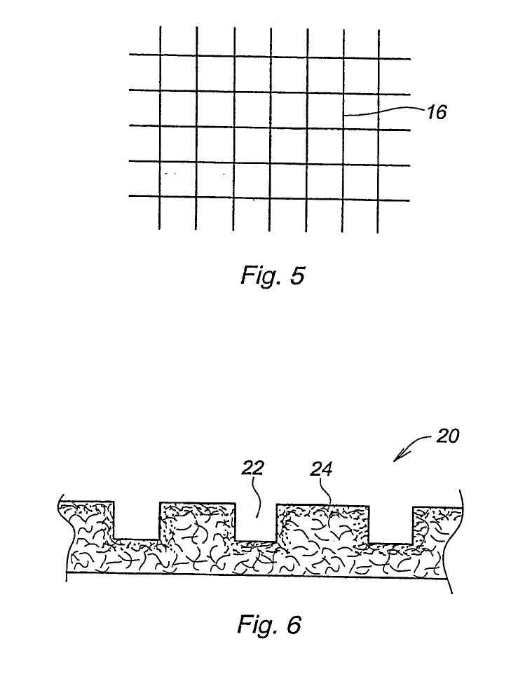

In FIG. 1b the detailed structure of water channels and how the water distribution is organized in a stack is shown. The left-hand side of the figure shows the upside and the right-hand side of the figure shows the down side. As schematically indicated the channels extend across the surface in parallel with each other. However, it is also possible to provide the channels in other geometrical patterns, e.g. as shown in FIG. 5, namely as a network like structure of channels 16.

Each sealing frame 2 in a stack has a number of holes made through it. The holes located in the corners are for clamping bolts used when assembling a number of cell units to a cell stack. The remaining holes, together with corresponding holes in the other components of a stack, form channels through the stack for water, fuel gas and oxidant gas respectively.

Furthermore, the upper side (as defined above) of the sealing 2 has gas channels 15 running along the inner edge of the frame like structure. A number of distribution apertures (in the figure there are five) are diverted from each gas channel 15, so as to distribute incoming gas into the distribution material located in the frame. The second hole from left (in the figure) in the upper array of holes is the inlet channel 9 for incoming gas, and the second hole from left in the lower array of holes is the outlet channel 10 for gas exiting from the cell on the anode side. The anode sealing 2 has the same configuration of gas channels regardless of position in the stack.

On the down side (as defined above) of each sealing 2 there are provided channels for water, having a common water inlet 11 and a common water outlet 12.

In the middle of the stack the membrane 4 is arranged, separating the anode and cathode parts of the stack. On the cathode side, a cathode gas distribution layer 5 is provided, and then there is sealing 6 for cathode wherein cathode gas inlet and outlet 13, 14 are formed, in a similar way as in the anode sealing 2.

In FIG. 3 there is schematically shown in cross section, a basic embodiment of the gas distribution member 3 for fuel cells according to the present invention.

The distribution member 3 is flat and comprises a porous, sintered felt like material, shaped so as to be capable of being fitted into the sealing frame 2, 6 (see FIGS. 1a-b) of an anode or cathode, respectively, of a fuel cell.

In the unpublished U.S. patent application Ser. No. 09/338,060 there is disclosed a method of manufacturing a shaped sintered porous body from inorganic fibers. The material so produced is suitable for the manufacture of a gas distribution member in accordance with the present invention. U.S. Ser. No. 09/338,060 is incorporated herein in its entirety by reference.

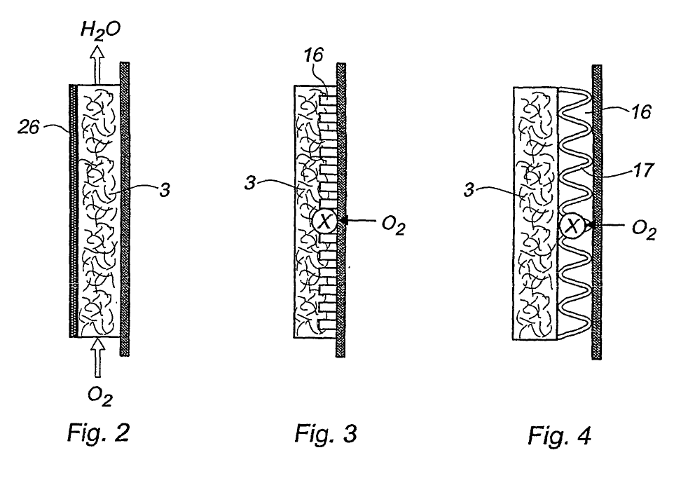

In FIG. 2 the distribution member has no water channels. In view of the high porosity of the material used for the distribution member, gas will be able to flow without a too high pressure drop.

However, in a preferred embodiment of the invention, there will be provided water channels 16 in the distribution member,as shown in FIGS. 3 and 4.

In FIG. 3 the water channels 16 are formed during the manufacture in a molding process. Suitably a suitably structured mold having a pattern of ridges corresponding to the desired channel pattern will be used, whereby the ridges will cause depressions in the surface. Preferably the channels are 50-1000 μm wide, especially 50-100 μm wide, and 100-1000 μm deep, preferably 100-300 μm deep. The spacing between channels over the channel pattern would suitably be about 200-1000 μm.

The gas distribution member is, as indicated above, made from a material based on inorganic fibers that are sintered to form a felt like material. Preferably a fiber material selected from the group consisting of steel, nickel and titanium is used. The diameter of the fibers can range from 0.5 μm up to 25 μm preferably 2-25, most preferred 8-22 μm, and a length in the range preferably up to 3 mm. The achievable width of the channels will of course depend on the diameter of the fibers.

In another embodiment illustrated in FIG. 4, the channels 16 are provided by corrugating the felt material 17. The method of making such a structure is disclosed in the above referenced U.S. Ser. No. 09/338,060.

The thus formed corrugated structure is assembled with a felt like member according to FIG. 2, to form the composite structure of FIG. 4. Also in this case the channels will preferably have the above mentioned dimensions.

In an alternative embodiment of the invention, the material for the gas distribution member can be made so as to have a porosity gradient throughout the thickness of the material. A preferred structure is when the porosity decreases towards the membrane. Such a material can be made by placing two or several sheets of the starting material with different porosity on top of each other in the manufacture of the gas distribution member. A material exhibiting such porosity can also be made from a material having a homogenous porosity by mechanical means, for example by pressing the material such that a gradient is obtained throughout the material, preferably simultaneously when water channels are pressed into the material. Other methods of providing the channels are by etching with suitable etchants, such as various acids or acid combinations, or by milling.

However, the gradient does not necessarily need to be throughout the whole thickness of the gas distribution member. It can for example in a further embodiment occur only in a thin portion of the layer, preferably the portion of the layer which is closest to the water channels and the membrane. This is schematically illustrated in FIG. 6, which is a cross-section through a gas distribution member 20 having channels 22 formed in its surface. The higher porosity in the surface layer 24 closest to the membrane (not shown) and in the channel walls is indicated by denser hatching.

During the compression procedure, the porosity will increase more at the interfaces than in the bulk of the material, and thus, as desired, there will be a gradient at least near the surfaces of the gas distribution member, for example when pressing water channels into the material. In this process a template is preferably employed, having a ridge structure surface corresponding to the desired water channel structure.

By providing a gradient there will be a lower porosity near the membrane. This is especially an advantage on the anode side, since one achieves a better water management and maintains a direct water contact between the gas distribution layer and the membrane. The dense section of the gas distribution layer with lower porosity can assist to obtain these desired effects.

In a further embodiment of the invention there should be a corrosion protection layer 26 provided on the gas distribution member, closest to the membrane, in order to protect against the acid proton conducting membrane. This corrosion protective layer also covers the channel walls, where such channels are provided. The layer is preferably hydrophobic and can be made of carbon or carbon based material. Also the edges of the gas distribution member can be treated so as to be hydrophobic, in order that no water be able to enter the porous bulk structure.

The inventive gas distribution member can be implemented in a fuel cell assembly as disclosed in FIGS. 1a-b without any modification in the principle for the structure thereof.

Modifications and variations of the invention are within the competence of the man skilled in the art, and the scope of the invention is only limited by the appended claims.

1. A gas distribution member for a polymer membrane fuel cell, characterized in that the gas distribution member (3) comprises a highly porous, sintered material.

2. The gas distribution member according to claim 1, wherein the sintered material comprises fibers of an inorganic material, preferably a material selected from the group consisting of steel, nickel and titanium.

3. The gas distribution member according to claim 2, wherein the fibers have a diameter in the range 0.5-50 μm, preferably 2-25 μm, most preferred 8-22 μm, and a length in the range up to 3 mm.

4. The gas distribution member according to any preceding claim, wherein the porosity is in the range of more than 50 percent by volume, preferably more than 90 percent by volume.

5. The gas distribution member according to any preceding claim, comprising channels (3a; 16; 22) formed in the surface thereof.

6. The gas distribution member according to any of claims 4 or 5, wherein the channels (3a, 16; 22) are 50-1000 μm wide, preferably 50-100 μm wide, and 100-1000 μm deep, preferably 100-300 μm deep, and wherein the spacing between channels are 200-1000 μm.

7. The gas distribution member according to any preceding claim, comprising a first member of a highly porous, sintered material, and a second member sandwiched to said first member, and exhibiting a corrugated structure (17), thereby forming channels (16).

8. The gas distribution member according to any of claims 1-4, exhibiting a porosity gradient in at least a surface region (24) thereof wherein the porosity is lowest at the surface.

9. The gas distribution member according to claim 8, wherein there is a porosity gradient at both surfaces of the member.

10. The gas distribution member according to any of claims 5-7, exhibiting a porosity gradient throughout the material, wherein the porosity is lowest at the channel walls.

11. A fuel cell, comprising a gas distribution member as claimed in claim 1.

12. The fuel cell according to claim 11, wherein each gas distribution member (3; 20) is enclosed by a coplanar sealing plate (2) with fuel gas and water channels coupled to the circumference of said members.

13. A method of making a gas distribution member for a polymer membrane fuel cell, comprising providing channels in the surface of said gas distribution member by pressing the material against a template exhibiting the desired pattern.

14. Method according to claim 13, comprising the further step of providing a porosity gradient throughout the material, preferably simultaneously with pressing water channels into the material.

15. A method of making a gas distribution member for a polymer membrane fuel cell, comprising providing channels in the surface of said gas distribution member by molding material in a suitably structured mold.
